(19) United States
(12) Patent Application Publication
(10) Pub. No.: US 2004/0105357 A1
(43) Pub. Date: Jun. 3, 2004

(54) RECORDING AND REPRODUCTION APPARATUS

(75) Inventors: Masayoshi SHIOYA, Hyogo (JP); Kiyoshi MASAKI, Hyogo (JP); Shinichi YAMADA, Osaka (JP)

Correspondence Address: SNELL & WILMER, ONE ARIZONA CENTER, 400 EAST VAN BUREN, PHOENIX, AZ, 850040001

(73) Assignee: MATSUSHITA ELECTRIC INDUSTRIAL CO., LTD., Osaka (JP)

(21) Appl. No.: 10/605,756

(22) Filed: Oct. 23, 2003

(30) Foreign Application Priority Data
Oct. 24, 2002 (JP) 2002-309329

(51) Int. Cl. G11B 7/095

(52) U.S. Cl. 369/44.29; 369/53.18

(57) ABSTRACT

A recording and reproduction apparatus, for irradiating a recording medium having a track with an optical beam to record information on and reproduce information from the recording medium, includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; and a control section for adjusting the prescribed value of the gain of the amplification section. The control section adjusts the prescribed value of the gain of the amplification section based on a linear velocity of the recording medium.

### BACKGROUND OF INVENTION

1. Field of the Invention

The present invention relates to a recording and reproduction apparatus for recording information on and reproducing information from a recording medium by an optical means.

2. Description of the Related Art

Optical recording and reproduction apparatuses are available for recording information on and/or reproducing information from a disc-shaped recording medium (for example, an optical disc) rotating at a prescribed rotation speed. One type of such optical recording and reproduction apparatuses perform recording and/or reproduction by converging an optical beam emitted by a semiconductor laser or the like mounted on an optical head, using an objective lens or the like and directing the laser beam toward the recording medium.

A recording medium used by such a recording and reproduction apparatus includes a small spiral track having a pitch of, for example, 0.6 μm. In order to record information on and/or reproduce information from such a track, it is necessary to perform tracking control such that an optical beam spot is always positioned on the track. An error signal used for tracking control, i.e., a tracking error signal is detected by receiving light reflected and diffracted by the track, by a light detector having a light receiving surface divided equally into two cells in the direction of the track, and then finding a difference between signals which are output from the two cells.

When the optical beam is at the center of the track, the signals which are output from the two cells have an equal amplitude, and thus the difference between the two signals, i.e., the tracking error signal is zero. This error detecting method is referred to as a push-pull method, and is widely used since this method allows a tracking error signal to be detected by a simple structure.

A tracking error signal is generated in accordance with the light reflected by the optical disc and its amplitude changes in accordance with the reflectance of the optical disc and the intensity of the optical beam directed toward the optical disc.

In general, when the amplitude of a tracking error signal changes, the value of the gain of a tracking control system changes and thus the control system becomes unstable. As a solution to this problem, an AGC circuit is provided in the tracking control system for obtaining TE/AS, where TE is the amplitude of the tracking error signal and AS is the amplitude of an amount signal which represents the light amount reflected by the optical disc.

It is generally well known that the tracking error signal amplitude TE changes in accordance with the depth of the track groove. One type of write-once-read-many optical discs, which allow information to be written once, record information by changing the depth of the track groove.

In such a type of optical discs, when information is recorded, the depth of the track groove is changed. If the AGC circuit is operated in this state, the tracking control system may become more unstable. As a solution against this phenomenon, the recording and reproduction apparatus is structured as shown in FIG. 9.

FIG. 9 shows an optical recording and reproduction apparatus 900 for recording information on and/or reproducing information from an optical disc by changing the depth of the track groove.

The optical recording and reproduction apparatus 900 includes an optical head 2, a motor 5, an adder 10, a differential amplifier 11, an AGC circuit 12, a two-cell light detector 19 having a light receiving surface divided equally into two cells, a gain variable amplifier 32, an information detection circuit 33, a microcomputer 34, and a tracking control circuit 35.

The optical head 2 records information on and/or reproduces information from the optical disc 31. The optical head 2 includes an objective lens 3. The optical disc 31 allows information to be recorded thereon by changing the depth of the track groove as described above. The motor 5 drives and thus rotates the optical disc 31. The two-cell light detector 19 includes cells 36 and 37. The two-cell light detector 19 is irradiated with light which has been reflected and diffracted by the track of the optical disc 31. An output from each of the cells 36 and 37 is input to the differential amplifier 11. The differential amplifier 11 generates a tracking error signal and inputs the tracking error signal to the AGC circuit 12.

An output from the AGC circuit 12 is output to the gain variable amplifier 32, and the gain variable amplifier 32 switches the gain in accordance with the output from the information detection circuit 33 and the output from the microcomputer 34, and amplifies the output signal from the AGC circuit 12.

The microcomputer 34 determines the type of the optical disc mounted on the optical recording and reproduction apparatus 900 through a detection hole or the like provided in a cartridge accommodating the optical disc, and confirms that the optical disc 31 allows information to be recorded thereon by changing the depth of the track groove. When this occurs, the microcomputer 34 sets the gain of the gain variable amplifier 32 to a prescribed value Xa.

In the optical disc 31, the depth of the track groove is different between an area where information has been recorded and an area where information has not been recorded. Therefore, the pre-recording relationship between a tracking error signal V0 and an amplitude AS of an amount signal of the reflected light, V0/AS, and the post-recording relationship between a tracking error signal V1 and an amplitude AS1 of an amount signal of the reflected light, V1/AS1, are not equal to each other.

Where the pre-recording output from the AGC circuit 12 is Va=K×(V0/AS) and the post-recording output from the AGC circuit 12 is Vb=K×(V1/AS1) (K is a constant), it is necessary to set the gain Xa or Xb in the gain variable amplifier 32 such that Xa×Va=Xb×Vb. Namely, when no information has been recorded on the track, the gain of the gain variable amplifier 32 is switched to Xa, and when information has been recorded on the track, the gain of the gain variable amplifier 32 is switched to Xb.

Next, how to distinguish a track on which information has been recorded and a track on which no information has been recorded will be described. With the optical disc 31 for allowing information to be recorded thereon by changing the depth of the track groove, when information is recorded on the track, the track groove becomes deeper and thus the light amount reflected by the track is decreased. Based on the output of the adder 10, whether information has been recorded or not can be detected. Therefore, the information detection circuit 33 determines, based on a change in the output of the adder 10, whether information has been recorded on the track or not, and outputs the determination result to the microcomputer 34. The microcomputer 34 switches the gain of the gain variable amplifier 32 based on the output from the information detection circuit 33 so as to make the gain of the tracking control system constant (see, for example, Japanese Laid-Open Publication No. 8-287490).

Recently, optical discs for allowing information to be recorded by deforming (or partially destroying) the track groove have become less common. Instead, optical discs for allowing information to be recorded by evaporating a portion of a recording film on the track groove using heat generated by laser light and thus forming marks have become mainstream.

While information is being recorded on such an optical disc, the recording film is in the middle of undergoing a physical state change. Therefore, TE/AS, i.e., the ratio of the amplitude TE of a tracking error signal with respect to the amplitude AS of an amount signal of the reflected light is different before recording and after recording.

In the case where the optical disc, for allowing information to be recorded by evaporating a portion of the recording film, is rotated at a linear velocity assumed when designing the recording film, marks are formed very rapidly when the laser output is strengthened to a prescribed level. Thus, the TE/AS ratio can be substantially equal before recording and after recording. In this case, only the AGC circuit 12 is required to stabilize the tracking control system, like information reproduction from a general optical disc. Once the linear velocity is increased, however, the recording conditions are changed from the conditions under which the recording film was set. Thus, the TE/AS ratio in the middle of recording becomes different from the TE/AS ratio before recording.

In an optical recording and reproduction apparatus, the light amount reflected by optical discs changes (i) due to production variances of the optical discs and contamination of the optical discs and (ii) in accordance with the difference in intensity of the laser light between recording and reproduction. In order to stabilize the tracking control system against such changes, it is indispensable to provide an AGC circuit. However, when information is recorded on the above-described type of write-once-read-many optical disc while changing the linear velocity, the intensity of the laser light directed to the track during recording is offset from the intensity of the laser light with which the recording medium was designed. As a result, the TE/AS ratio during recording is decreased (or increased). If the AGC circuit is operated in such a state, the tracking control system becomes unstable rather than being stabilized.

When a tilt occurs, the tracking control system becomes unstable for a similar reason.

In the above-described optical recording and reproduction apparatus 900, it is attempted to improve the stability of the tracking control system by switching the gain of the gain variable amplifier 32 before recording and after recording. However, the timing of switching is determined only by the information detection circuit 33, which determines whether the information has been recorded or not by detecting the light amount reflected by the optical disc. Therefore, it is difficult to change the timing of switching in accordance with the change in the TE/AS ratio during recording.

In the case of an optical disc for allowing information to be recorded thereon by evaporating a portion of the recording medium on the track using heat generated by laser light and thus forming marks, the TE/AS ratio during recording is different between when the optical disc is rotated at a normal rotation speed and when the optical disc is rotated at high speed. However, the above-described apparatus 900 does not detect the change in the rotation speed, and thus cannot change the timing of switching in accordance with this change.

In the optical discs described so far, the power of the laser light directed to a desired position on the optical disc during recording is reduced by external factors including a tilt, and thus the TE/AS ratio during recording is changed. As a result, the tracking control system becomes unstable. The above-described apparatus 900 does not detect the external factors including a tilt, and thus cannot change the timing of switching in accordance with the change in the TE/AS ratio caused by such external factors.

### SUMMARY OF INVENTION

According to one aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; and a control section for adjusting the prescribed value of the gain of the amplification section. The control section adjusts the prescribed value of the gain of the amplification section based on a linear velocity of the recording medium.

In one embodiment of the invention, the control section adjusts the prescribed value of the gain of the amplification section when recording the information on the recording medium.

In one embodiment of the invention, the recording and reproduction apparatus further includes a determination section for determining whether or not information is recorded at a position, which is irradiated with the optical beam, on the recording medium. The control section changes the prescribed value of the gain of the amplification section based on the result of the determination section on whether or not the information is recorded at the position, which is irradiated with the optical beam, on the recording medium.

In one embodiment of the invention, the determination section includes a reproduction section for reproducing the information recorded on the recording medium; and a comparison section for comparing an output value from the reproduction section and a prescribed value. The determination section determines, based on the result of the comparison, whether or not the information is recorded at the position, which is irradiated with the optical beam, on the recording medium.

In one embodiment of the invention, the amplification section includes an amount signal output section for outputting an amount signal of reflected light based on a light amount reflected by the recording medium; a first gain variable amplification section having a value of a gain thereof changed based on the amount signal of the reflected light; and a second gain variable amplification section having a value of a gain thereof adjusted by the control section.

In one embodiment of the invention, the amount signal output section outputs an amount signal, of reflected light, having a fixed amplitude when recording the information on the recording medium.

In one embodiment of the invention, the amplification section includes an amount signal output section for outputting an amount signal of reflected light based on a light amount reflected by the recording medium; and a gain variable amplification section having a value of a gain thereof changed based on at least one of the amount light signal of the reflected light and an instruction from the control section.

In one embodiment of the invention, the amount signal output section outputs an amount signal, of the reflected light, having a fixed amplitude when recording the information on the recording medium.

In one embodiment of the invention, the amplification section includes an amount signal output section for outputting an amount signal of reflected light based on a light amount reflected by the recording medium; a third gain variable amplification section for amplifying and outputting the amount signal of the reflected light, the third gain variable amplification section having a value of a gain thereof adjusted by the control section; and a fourth gain variable amplification section for amplifying and outputting the tracking error signal, the fourth gain variable amplification section having a value of a gain thereof adjusted based on the amount signal, of the reflected light, amplified by the third gain variable amplification section.

In one embodiment of the invention, the amount signal output section outputs an amount signal, of reflected light, having a fixed amplitude when recording the information on the recording medium.

In one embodiment of the invention, a recording film of the recording medium contains an organic pigment material which is irreversibly changed using heat generated by irradiation with the optical beam.

In one embodiment of the invention, the recording and reproduction apparatus further includes a gain switching section for switching a value of a gain of the tracking error detection section. The gain switching section switches the value of the gain of the tracking error detection section based on whether information is to be recorded on the recording medium or information is to be reproduced from the recording medium.

According to another aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a tilt detection section for detecting a tilt between a normal with respect to a position, which is irradiated with the optical beam, on the recording medium and an optical axis of the optical beam. The control section adjusts the prescribed value of the gain of the amplification section based on the detected tilt.

According to still another aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a sensitivity detection section for detecting a recording sensitivity of the recording medium. The control section adjusts the prescribed value of the gain of the amplification section based on the detected recording sensitivity.

In one embodiment of the invention, recording medium has sensitivity information representing the recording sensitivity recorded thereon. The sensitivity detection section detects the sensitivity information based on reflected light by the recording medium.

According to still another aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a transfer section for transferring the optical beam in a radial direction of the recording medium. The control section adjusts the prescribed value of the gain of the amplification section based on a position of the optical beam in the radial direction.

According to still another aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a modulation section for modulating the optical beam based on information to be recorded on the recording medium. The control section adjusts the prescribed value of the gain of the amplification section based on an average intensity of the modulated optical beam.

According to still another aspect of the invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a temperature measurement section for measuring a temperature of the recording medium. The control section adjusts the prescribed value of the gain of the amplification section based on the measured temperature.

Thus, the invention described herein makes possible the advantages of providing a recording and reproduction apparatus capable of performing stable tracking control when recording information on and/or reproducing information from a recording medium, for example, an optical disc for allowing information to be recorded thereon by evaporating, fusing or deforming a portion of a recording film using heat generated by laser light and thus forming marks.

These and other advantages of the present invention will become apparent to those skilled in the art upon reading and understanding the following detailed description with reference to the accompanying figures.

### BRIEF DESCRIPTION OF DRAWINGS

FIG. 1 shows an optical recording and reproduction apparatus according to a first example of the present invention;

FIG. 2 is a timing diagram illustrating a tracking error signal and a light amount sum signal obtained from a track where no information has been recorded, a track where information is being recorded, and a track where information has been recorded;

FIG. 3 shows an optical recording and reproduction apparatus according to a second example of the present invention;

FIG. 4 shows an optical recording and reproduction apparatus according to a third example of the present invention;

FIG. 5 shows a temperature change of an optical disc;

FIG. 6A shows a structure of an amplification section of an optical recording and reproduction apparatus according to the present invention;

FIG. 6B shows an alternative structure of the amplification section;

FIGS. 7A and 7B shows alternative structures of the amplification section;

FIG. 8 shows the relationship between input data and a change in the intensity of an optical beam; and

FIG. 9 shows a conventional optical recording and reproduction apparatus.

### DETAILED DESCRIPTION

Hereinafter, the present invention will be described by way of illustrative examples with reference to the accompanying drawings.

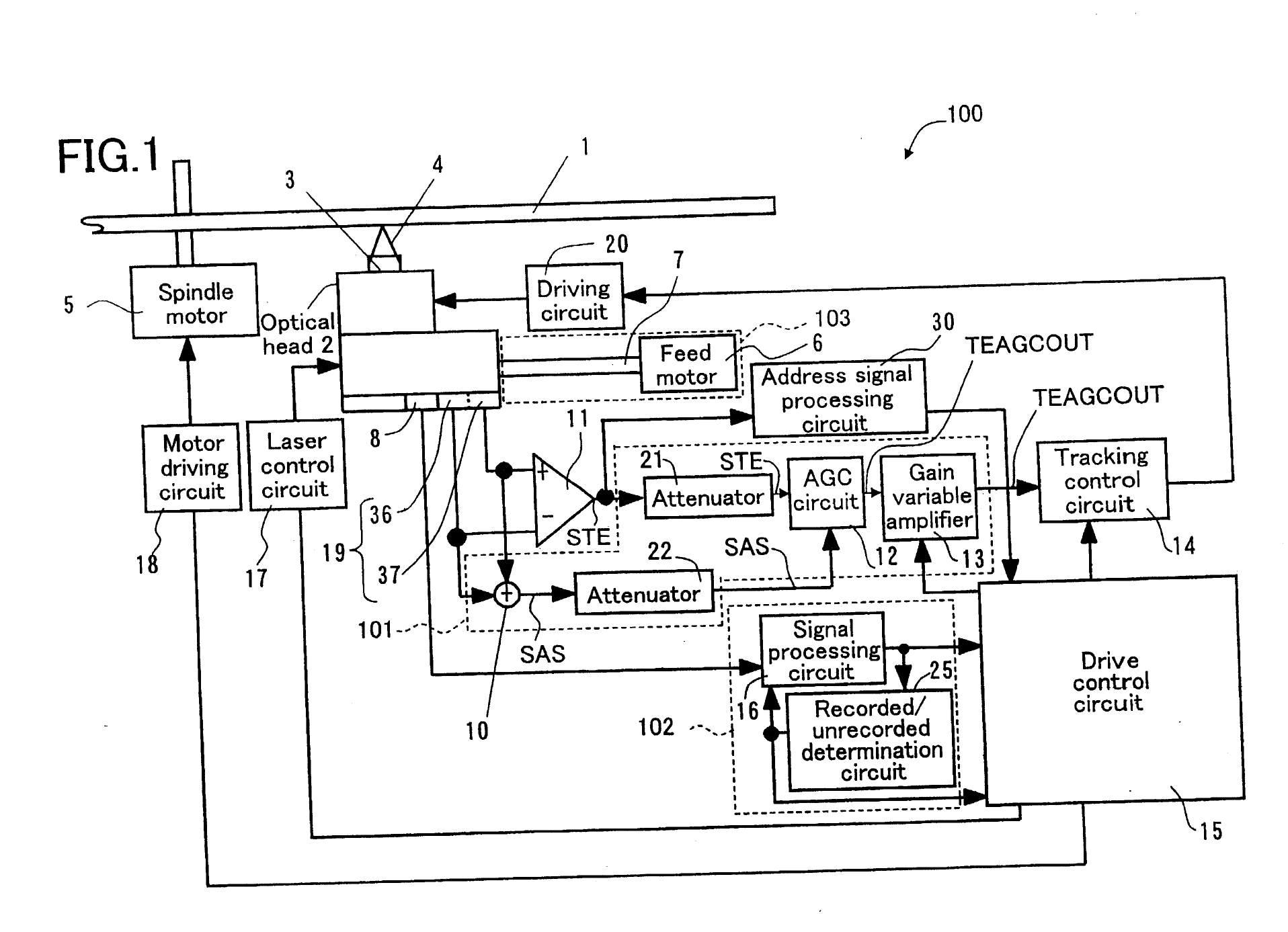

(Example 1) FIG. 1 shows an optical recording and reproduction apparatus 100 according to a first example of the present invention. The optical recording and reproduction apparatus 100 includes an optical head 2, a spindle motor 5, a differential amplifier 11, a tracking control circuit 14, a drive control circuit 15, a laser control circuit 17, a motor driving circuit 18, a driving circuit 20, an address signal processing circuit 30, an amplification section 101, a determination section 102, and a transfer section 103. The amplification section 101 includes an adder 10, attenuators 21 and 22, an AGC circuit 12, and a gain variable amplifier 13. The determination section 102 includes a signal processing circuit 16 and a recorded/unrecorded determination circuit 25. The transfer section 103 includes a feed motor 6 and a feed screw 7.

The optical head 2 records information on and/or reproduces information from an optical disc 1 by irradiating the optical disc 1 with an optical beam 4. The optical head 2 includes an objective lens 3, a signal detection light detector 8, and a two-cell light detector 19. The optical disc 1 is a disc-shaped recording medium. The spindle motor 5 drives and rotates the optical disc 1. The two-cell light detector 19 includes cells 36 and 37. The two-cell light detector 19 is irradiated with light which has been reflected and diffracted by a track of the optical disc 1. An output from each of the cells 36 and 37 is input to the differential amplifier 11. The differential amplifier 11 generates a tracking error signal STE and inputs the tracking error signal STE to the AGC circuit 12.

The optical disc 1 includes a plurality of tracks formed thereon. Each track is wobbled by a very small amount at a prescribed period. An address signal is formed by such a small wobble and a small bridge structure connecting tracks. The address signal is used for detecting the position on a track which is being irradiated with the optical beam 4. An innermost area of optical disc 1 includes an area referred to as a control track. In the control track, information on the optical disc 1 including the format, the track pitch and the recording sensitivity is recorded.

The optical disc 1 is placed on the spindle motor 5 and rotated at a prescribed rotation speed. The optical disc 2 records information on or reproduces information from the optical disc 1. The optical head 2 further includes an actuator (not shown) for driving the objective lens 3, an optical device such as a prism (not shown), a semiconductor laser (not shown), and two-cell light detectors 8 and 19. The optical head 2 is moved in a radial direction of the optical disc 1 by the feed motor 6 including a stepping motor or the like and the feed screw 7.

Light emitted by the semiconductor laser provided in the optical head 2 is collected on the optical disc 1 by the objective lens 3. The light reflected by the optical disc 1 is split by an optical system (not shown) provided in the optical head 2. Each component of the light obtained by the splitting is directed to the two-cell light detector 8 for detecting a signal, the two-cell light detector 19 for detecting a tracking error signal, and a light detector (not shown) for detecting a focusing error signal.

The two-cell light detector 19 is irradiated with the light which has been reflected and diffracted by a track of the optical disc 1. An output from each of the cells 36 and 37 of the two-cell light detector 19 is input to the differential amplifier 11. The differential amplifier 11 acts as a tracking error detection section for detecting a positional offset between the light beam 4 and the track, and outputting a tracking error signal STE representing the detected positional offset. The output from each of the cells 36 and 37 is output to the adder 10, which generates a light amount sum signal SAS representing the light amount reflected by the track. In this specification, the term “light amount sum signal” and the term “amount signal of reflected light” are used interchangeably.

The tracking error signal STE is input to the AGC circuit 12 via the attenuator 21. The AGC circuit 12 includes, for example, a VCA, and has a value of a gain thereof changed in accordance with the light amount sum signal SAS. An amplitude TE2 of a tracking error signal TEAGCOUT output from the AGC circuit 12 is represented by TE2=AS0×TE/AS. “AS” is the amplitude of the light amount sum signal SAS, and “TE” is the amplitude of the tracking error signal. “AS0” is the amplitude of a reference light amount sum signal (light amount sum signal level). When the light amount sum signal amplitude AS which is detected by the adder 10 is equal to the amplitude AS0 of the reference light amount sum signal, the tracking error signal amplitude TE which is output from the differential amplifier 11 is equal to the amplitude TE2 of the tracking error signal TEAGCOUT. When the light amount sum signal amplitude AS which is detected by the adder 10 is twice as large as the amplitude AS0 of the reference light amount sum signal, TE2=TE/2.

In general, TE and AS change in proportion to each other. Therefore, even when the intensity of the optical beam 4 is increased or the reflectance of the optical disc 1 is changed to increase the reflected light amount, the tracking error signal TEAGCOUT is kept substantially at a constant value by using the AGC circuit 12.

The tracking error signal TEAGCOUT is input to the gain variable amplifier 13 including, for example, a VCA. The gain variable amplifier 13 amplifies the tracking error signal TEAGCOUT based on the gain (the amplification ratio may be smaller than 1), and outputs the amplified tracking error signal TEAGCOUT. The gain used by the gain variable amplifier 13 may be adjusted. The operation of the gain variable amplifier 13 will be described in detail below.

The amplified tracking error signal TEAGCOUT output by the gain variable amplifier 13 is input to the tracking control circuit 14 including a filter. The tracking control circuit 14 controls the position of the beam based on the amplified tracking error signal TEAGCOUT. The amplified tracking error signal TEAGCOUT is applied to the driving circuit 20 via the tracking control circuit 14, and thus a tracking coil (not shown) which is a part of the actuator (not shown) in the optical head 2 is driven. In this manner, a current in accordance with the tracking error signal amplitude TE flows in the tracking coil (not shown), and the objective lens 3 is tracking-controlled such that the optical beam 4 is always on a track of the optical disc 1.

As described above, a portion of the light reflected by the optical disc 1 is directed to the light detector 8 for detecting a signal. The output from the light detector 8 is input to the signal processing circuit 16. The signal processing circuit 16 acts as a reproduction section for reproducing the information recorded on the optical disc 1. Although not shown, the signal processing circuit 16 includes an AC component extraction current including a capacitor or the like, a high speed AGC circuit and a filter that together adjust an AC component extracted from the light detector 8 to a prescribed amplitude. The signal processing circuit 16 also includes an equalizer circuit, a binarization circuit and the like, and detects the information recorded on the optical disc 1 based on the output from the light detector 8. The detected information is input to the drive control circuit 15 including a CPU, a DSP, and a high speed hard logic which operate at a high frequency. Thus, the information recorded on the optical disc 1 is read.

The output from the differential amplifier 11 is input to the address signal processing circuit 30. Although not shown, the address signal processing circuit 30 includes a high speed AGC circuit, a band pass filter, a voltage comparator and the like. The address signal processing circuit 30 extracts a signal from the tracking error signal STE based on the small wobbles of the tracks and a small bridge structure connecting the tracks. Then, the address signal processing circuit 30 binarizes the extracted signal and outputs the obtained binary signal to the drive control circuit 15. The drive control circuit 15 determines the position of the optical beam 4 on the optical disc 1 based on the output from the address signal processing circuit 30, and controls the rotation speed of the spindle motor 5 via the motor driving circuit 18 such that the linear velocity of the track to which the optical beam 4 is directed is constant.

Instructed by an external instruction device (not shown), the drive control circuit 15 modulates information data which is externally input at high speed using the high speed hard logic provided therein, and outputs the modulated information data to the laser control circuit 17. The laser control circuit 17 converts the output from the drive control circuit 15 into an electric current signal and drives the semiconductor laser (not shown) on the optical head 2 to change the intensity of the optical beam 4. Thus, the information is recorded on the optical disc 1.

The recording film of the optical disc 1 for recording information contains an organic pigment material or the like. When, for example, laser light having a high intensity of about 10 mW is directed to the recording film, a portion of the recording film is evaporated. As a result, the track is deepened and the light amount reflected by the track is decreased. The drive control circuit 15 reads the change in the reflected light amount from the recorded/unrecorded determination circuit 25 (described below) and detects whether or not information has been recorded on the track of the optical disc 1 which is currently being reproduced.

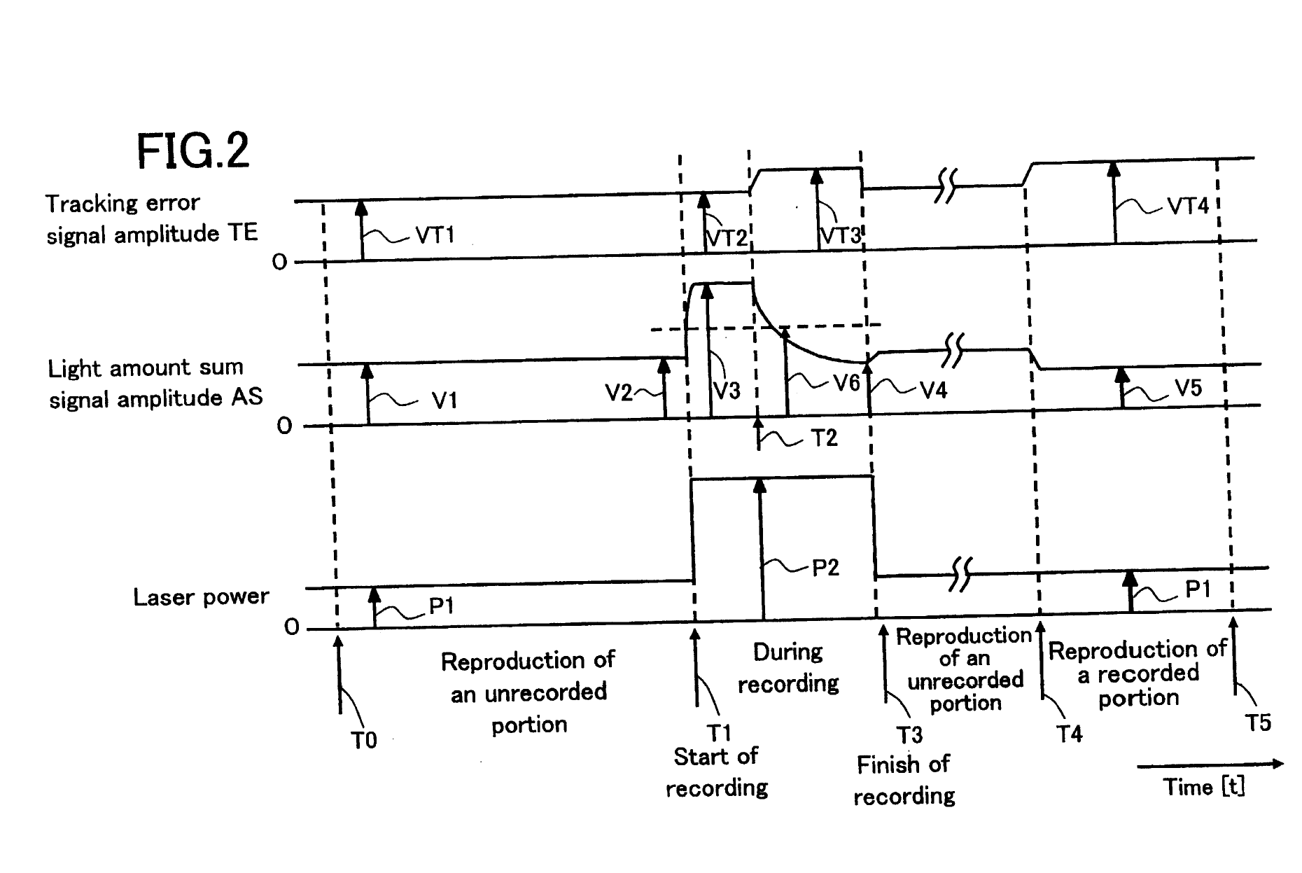

Next, with reference to FIG. 2, the relationship between the tracking error signal amplitude TE and the light amount sum signal amplitude AS will be described. FIG. 2 is a timing diagram of the tracking error signal TE and the light amount sum signal amplitude AS, which are input to the AGC circuit 12.

As shown in FIG. 2, when the laser power level is changed from P1 to P2 for recording information (time T1), the tracking error signal amplitude TE and the light amount sum signal amplitude AS change in accordance with the change in the intensity. The driving control circuit 15 switches the intensity of the optical beam 4 from P1 to P2 at time T1 by the laser control circuit 17, and simultaneously operates the attenuators 21 and 22 to double (P1/P2) the amplitudes of the outputs from the differential amplifier 11 and the adder 10. Thus, even when the level of the laser power is different between recording and reproduction, the tracking error signal amplitude TE and the light amount sum signal amplitude AS change only very slightly.

In the period from time T0 to time T1, a track of the optical disc 1 where no information has been recorded is irradiated with a laser beam having laser power P1 (information reproduction laser power). During this period, the tracking error signal amplitude is VT1, and the light amount sum signal amplitude is V1.

In the period from time T1 to time T3, a track of the optical disc 1 where no information has been recorded is irradiated with a laser beam having laser power P2 (information recording laser power). During this period, the tracking error signal amplitude changes from VT2 and VT3, and the light amount sum signal amplitude changes from V2 to V3 and to V4. As shown in FIG. 2, even when the track is irradiated with the laser beam having the high laser power P2, the tracking error signal amplitude does not change (VT1=VT2) until a recording mark starts to be formed. By contrast, the light amount sum signal amplitude increases from V2 to V3 immediately when the track is irradiated with the laser beam having the high laser power P2.

At time T2, i.e., when the temperature of the recording film is raised and a portion of the recording film is evaporated to deepen the track, the tracking error signal amplitude increases from VT2 to VT3 and the light amount sum signal amplitude gradually decreases from V3. This occurs because the formation of the mark increases the ratio of a portion having a lower reflectance with respect to the area irradiated with the light beam 4. “V4” represents the amplitude of the light amount sum signal when the ratio of the recorded portion in the area irradiated with the light beam 4 is maximum.

In the period between time T4 and time T5, the light beam 4 passes the recording mark. During this period, the tracking error signal amplitude is VT4 (=VT3), and the light amount sum signal amplitude is V5 (<V4).

In the case where the recording laser power P2 of the laser beam directed to the optical disc 1 matches the designing condition of the recording film of the optical disc 1, a recording mark is formed instantaneously. Therefore, the light amount sum signal amplitude during information recording is substantially V4 and the tracking error signal amplitude is substantially VT3. At this point, the amplitude TE2 of the tracking error signal TEAGCOUT from the AGC circuit 12 is TE2=V1×VT3/VT4 where the reference light amount sum signal amplitude is V1.

Accordingly, the gain change of the tracking control system during normal recording is (V1/VT1)×(VT3/V4). In order to make the gain change of the tracking control system close to zero during recording as well as during reproduction, the amplification ratio of the attenuator 21 provided in a section for processing the tracking error signal is adjusted to (P1/P2)×(V4/VT3)×(VT1/V1).

When the linear velocity is increased, the moving rate of the track is increased. As a result, the time period in which the laser beam is directed to the same portion of the track is shortened, and the laser power directed to the same portion of the track is decreased. In such a case, the temperature of the recording film does not rise in the period between time T1 and time T2. Since the recording mark is not formed, the reflected light amount is kept at held at V3.

In this case, the average amplitude of the light amount sum signals which are input to the AGC circuit 12 is V6, which is the average thereof during the period between time T1 and time T3.

Accordingly, TEAGCOUT=V1×VT2/V6. The gain change in the tracking control system in this case is (V1/VT1)×(VT2/V3)=(V1/V6). Here, VT2=VT1.

When the gain of the attenuator is adjusted as described above, the change of the gain made by the adjustment is further added to the gain. Thus, the total gain change of the tracking control system is (V1/V3)×(V4/VT3)×(VT1/V1)=(VT1/V6)×(V4/VT3). When the linear velocity was doubled, the total gain change obtained in the experiment was −3 dB.

The area in the track of the optical disc 1 in which the light amount sum signal amplitude of V3 is obtained (the time period between time T1 and time T2 in FIG. 2) changes in accordance with the linear velocity. When the linear velocity increases, such an area is extended and thus the average light amount sum signal amplitude V6 increases. As the average light amount sum signal amplitude V6 increases, the gain of the tracking control system decreases. In order to improve the stability of the tracking control system even when the linear velocity is extremely high, it is necessary to compensate for the gain decrease.

The optical recording and reproduction apparatus 100 according to the present invention includes the gain variable amplifier 13 as shown in FIG. 1. By switching the gain of the gain variable amplifier 13 in accordance with the linear velocity, the tracking control system can be stabilized regardless of the linear velocity.

The gain variable amplifier 13 will be described hereinafter. The gain variable amplifier 13 includes a VCA or the like, and has the gain thereof controlled by the drive control circuit 15. Since the drive control circuit 15 controls the rotation speed of the spindle motors as described above, the drive control circuit 15 can switch the gain of the gain variable amplifier 13 in accordance with the linear velocity of the track irradiated with the optical beam 4.

The relationship between the gain which is set for the gain variable amplifier 13 and the linear velocity can be determined by measuring the relationship between the linear velocity and the gain change of the tracking control system, using a prescribed reference optical disc in, for example, the production process of the optical recording and reproduction apparatus 100 and then storing the measurement result in an EEPROM or the like.

A control track of the optical disc 1 has sensitivity information recorded therein. The sensitivity information represents the recording sensitivity of the optical disc 1.

When the optical disc 1 is mounted on an optical recording and reproduction apparatus and the apparatus is started, the information on the format and track pitch of the optical disc 1 is read from the control track. Thus, the signal processing circuit, the motor circuit and the like of the optical recording and reproduction apparatus are adjusted to be in a suitable state for recording information on and/or reproducing information from the optical disc 1. With the optical recording and reproduction apparatus 100 in the first example of the present invention, information on the recording sensitivity of the optical disc 1 is read as well as the format and track pitch of the optical disc 1 when the optical recording and reproduction apparatus 100 is started. By such an operation, the gain of the gain variable amplifier 13 can be adjusted to a level compatible with the recording sensitivity of the optical disc 1. For example, the signal processing circuit 16 acts as a sensitivity detection section for detecting the recording sensitivity of the optical disc 1 based on the sensitivity information. The drive control circuit 15 adjusts the gain of the gain variable amplifier 13 based on the detected recording sensitivity of the optical disc 1.

Owing to such an operation, the tracking control system can be stabilized even in the following case: An optical disc having a very low recording sensitivity is mounted on the optical recording and reproduction apparatus 100, but information is recorded to this optical disc at the optical beam intensity which is used for an optical disc having a standard recording sensitivity; and the light amount sum signal amplitude (shown in the period between time T1 and time T2 of FIG. 2) is kept at V3 for a relatively long time; as a result, the output level of the AGC circuit 12 is lowered and the gain of the tracking control system is decreased.

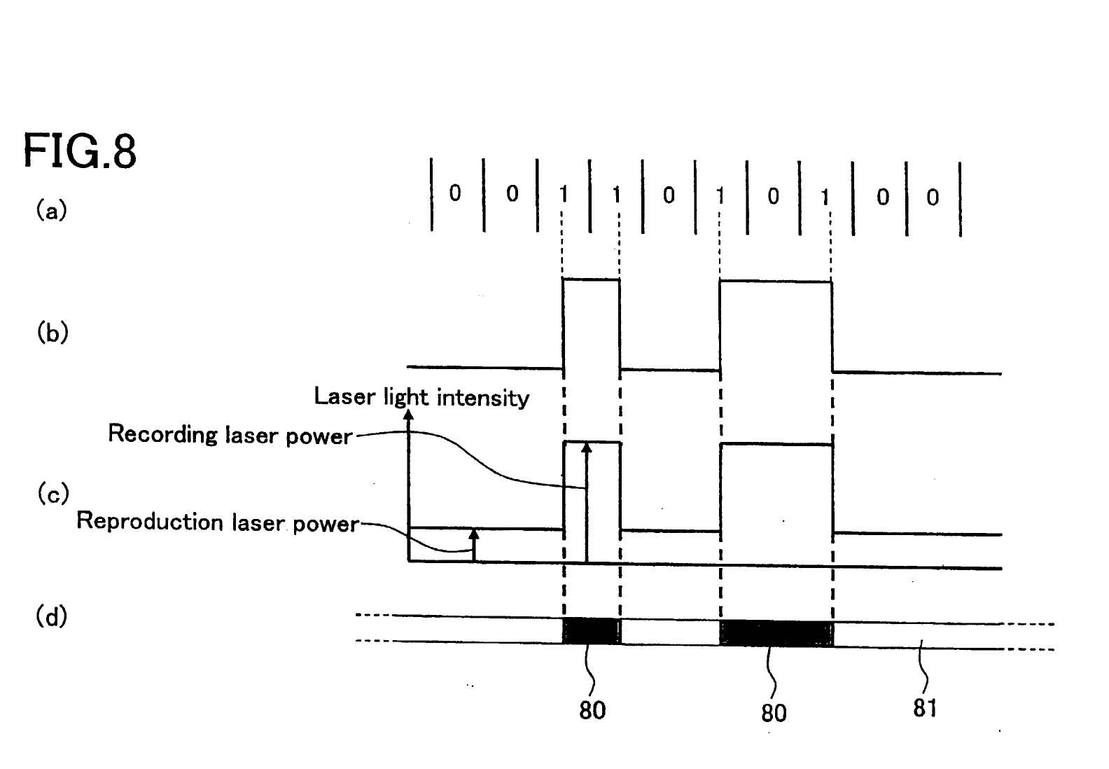

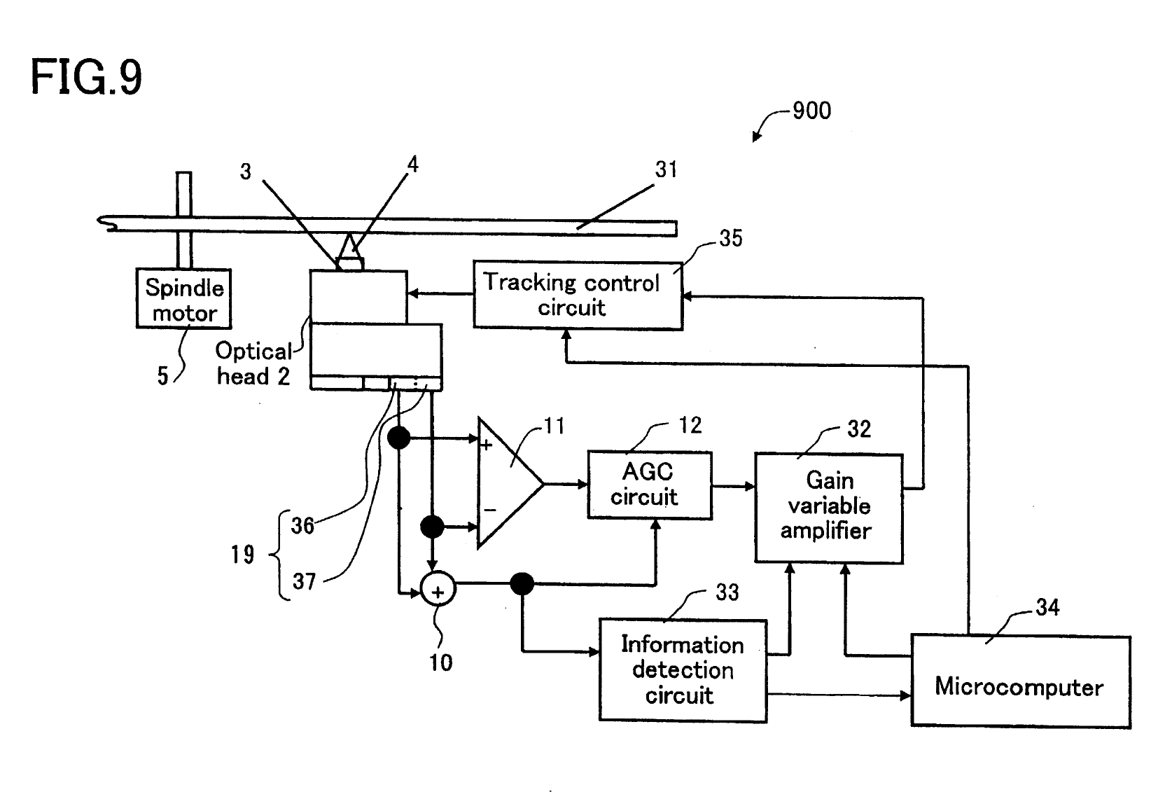

As described above, the drive control circuit 15 follows the instruction from the external instruction device (not shown) to modulate the externally input information data at high speed using the high speed hard logic. Then, the drive control circuit 15 outputs the modulated information data to the laser control circuit 17. The laser control circuit 17 converts the output from the drive control circuit 15 into an electric current signal. Thus, the semiconductor laser (not shown) in the optical head 2 is driven, and the intensity of the optical beam 4 is changed. In this manner, information is recorded on the optical disc 1. This will be described with reference to FIG. 8.

FIG. 8 illustrates the relationship between the input data and the change in the intensity of the optical beam. Part (a) of FIG. 8 shows a data stream which is externally input. Part (b) of FIG. 8 shows a data stream obtained by performing NRZI modulation of the data stream shown in part (a). Part (c) of FIG. 8 shows an optical beam modulated by the data stream shown in part (b). Part (d) of FIG. 8 shows a recording mark 80 which is formed in a track 81 of the optical disc 1. As is clear from FIG. 8, the frequency at which the intensity of the optical beam is increased changes in accordance with whether the input data stream includes more “0” data or more “1” data. When a data stream including more “0” data is recorded using, for example, NRZI modulation, the average intensity of laser light is lowered during recording as described above. Therefore, the temperature of the optical disc 1 is not easily increased. For recording “1” data, the average light amount sum signal amplitude is kept at V3 (FIG. 2) for a relatively longtime. As a result, the output level from the AGC circuit 12 is lowered, and the gain of the tracking control system is decreased. According to the present invention, the drive control circuit 15 manages the pattern of the data to be recorded. Therefore, it is possible to change the gain of the gain variable amplifier 13 in accordance with the data to be recorded, so as to stabilize the tracking control system. In this case, the drive control circuit 15 adjusts the gain of the gain variable amplifier 13 based on the average intensity of the modulated optical beam.

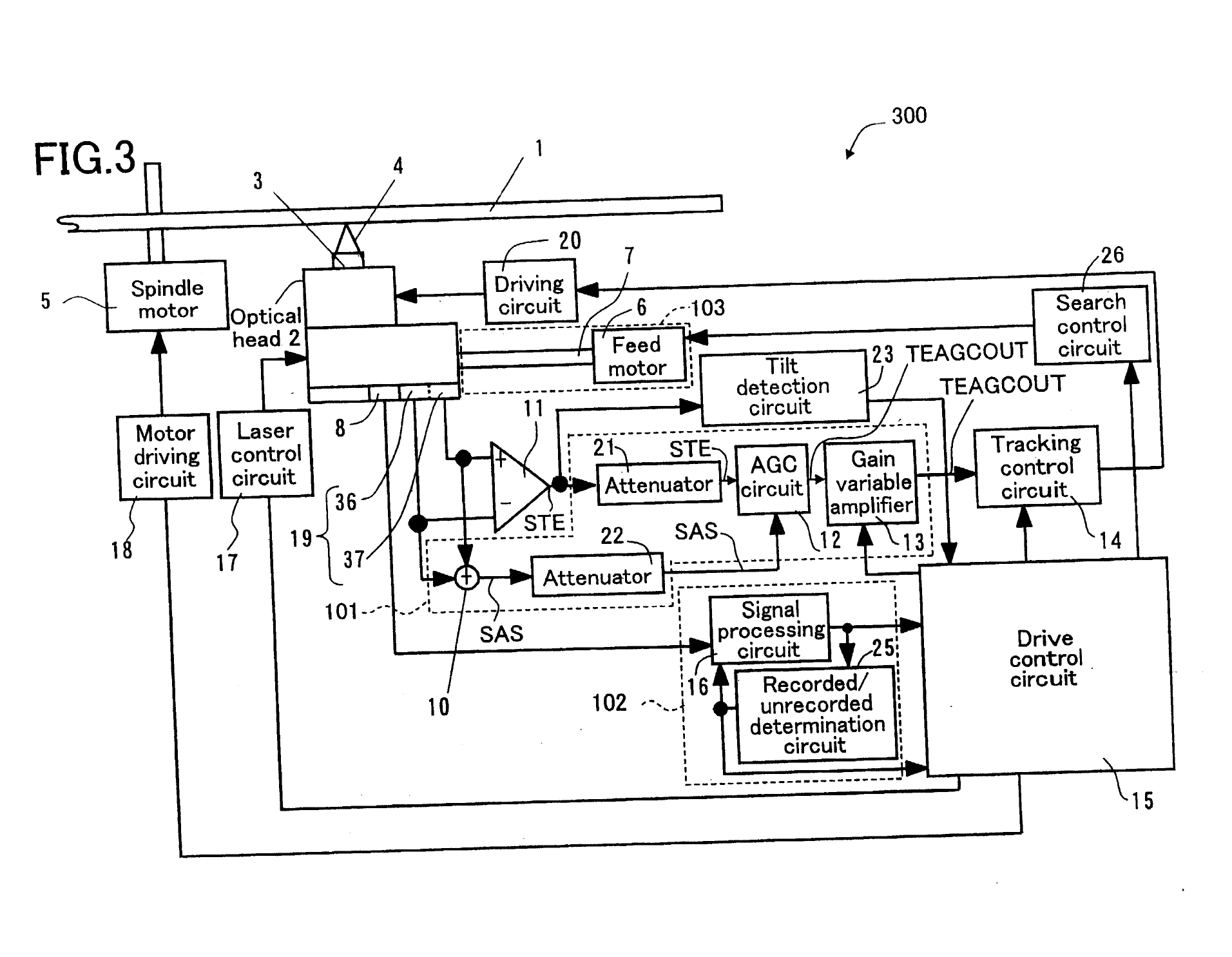

(Example 2) FIG. 3 shows an optical recording and reproduction apparatus 300 according to a second example of the present invention.

In the second example, recording and reproduction in the case where a tilt occurs will be described. When a tilt occurs, the optical beam 4 is directed obliquely with respect to the track of the optical disc 1. In a consequence, a phenomenon similar to the one occurring when the intensity of the optical beam 4 is lowered occurs.

When, simply, the intensity of the optical beam 4 is lowered and thus the tracking error signal amplitude and the light amount sum signal amplitude are decreased, such a decrease can be compensated for by the usual operation of the AGC circuit 12. When the intensity of the laser light directed to a desired position on the optical disc 1 is decreased by a tilt which occurs during information recording to a level outside the range of recording conditions for the optical disc 1, the temperature of the recording film is not raised sufficiently and thus there is a delay in the formation of a mark. As a result, a period in which the amplitude of the light amount sum signal is held at V3 (FIG. 2) for a relatively long time is generated. When this state is occurs, the value of the gain of the tracking control system is decreased and the tracking control system becomes unstable. In order to avoid this, the gain of the gain variable amplifier 13 needs to be switched in accordance with the generated tilt. This will be described with reference to the optical recording and reproduction apparatus 300 shown in FIG. 3.

In FIG. 3, identical elements previously discussed with respect to FIG. 1 bear identical reference numerals and the detailed descriptions thereof will be omitted. The optical recording and reproduction apparatus 300 includes a tilt detection circuit 23 and a search control circuit 26 in addition to the elements of the optical recording and reproduction apparatus 100 shown in FIG. 1.

As described above, the tracking error signal STE is detected by receiving light reflected and diffracted by a track of the optical disc 1 by the two-cell light detector 19 having the receiving surface divided into two cells 36 and 37, and finding a difference between signals respectively output from the cells 36 and 37 of the two-cell light detector 19 (push-pull method). It is generally known regarding the detection of a tracking error signal by the push-pull method that when a tilt occurs, a DC offset is generated in accordance with the amount of the tilt. The “tilt” is a state where a normal to the recording surface of the optical disc 1 and the optical axis of the optical beam 4 do not match each other. The DC offset component can be specifically measured based on the output from the differential amplifier 11 by disabling the tracking control circuit 15.

The tilt detection circuit 23 includes a peak detection circuit (not shown), a bottom detection circuit (not shown) and the like. The tilt detection circuit 23 measures a peak value and a bottom value of the tracking error signal STE which is output from the differential amplifier 11, detects the DC component (representing the tilt) of the tracking error signal from the difference between the peak value and the bottom value, and outputs the detected difference to the drive control circuit 15. The drive control circuit 15 detects a tilt amount from the DC component. The drive control circuit 15 adjusts the gain of the gain variable amplifier 13 based on the detected tilt amount.

In order to detect the DC offset component of the tracking error signal, it is indispensable that the tracking control circuit 14 should be disabled.

In the optical recording and reproduction apparatus 300, the tracking control circuit 14 is disabled during a search operation (seek operation) for moving the optical beam 4 to a desired track. Utilizing this operation, the tilt amount can be measured.

Next, a search operation in the optical recording and reproduction apparatus 300 will be described. The “search operation” in this example is defined as an operation for moving the optical beam 4 to a track of the optical disc 1 at which desired information is recorded.

In the optical recording and reproduction apparatus 300, the optical beam 4 is moved to a desired track for recording or reproducing information. For moving the optical beam 4, the drive control circuit 15 converts a distance by which the optical beam 4 needs to be moved (the distance between the current reproduction position and the track to which the optical beam 4 is to be moved) into a number of pulses corresponding to an angle by which the feed motor 6 is to be rotated. The obtained number of pulses is set in the search control circuit 26. Next, the tracking control circuit 14 is once disabled, and the search control circuit 26 is operated to drive the feed motor 6. The search control circuit 26 includes a counter, a pulse generation circuit and the like. When the drive control circuit 15 sets the number of pulses, the search control circuit 26 sequentially outputs the pulses of the set number to the feed motor 6 and rotates the feed motor 6. Thus, the optical head 2 is moved in a radial direction of the optical disc 1 by a desired distance. When the optical head 2 is moved by the desired number of pulses, the drive control circuit 15 again operates the tracking control circuit 14. In an actual search operation, the technique referred to as “jumping” is also used. “Jumping” means transferring the objective lens 3 by a distance corresponding to one track or a plurality of tracks without operating the feed motor 6. Details of the search operation will not be described herein since they are not directly relevant to the essence of the present invention.

A tilt map of the optical disc 1 can be created as follows. While operating the search control circuit 26, the optical beam 4 is transferred in a radial direction of the optical disc 1. Thus, the DC components of the tracking error signal (tilt amounts) are measured. Data regarding the measured tilt amounts are accumulated in a RAM (not shown) or the like of the drive control circuit 15. Thus, the tilt map of the optical disc 1 can be created in the drive control circuit 15.

When measuring a tilt amount, it is desirable to transfer the optical beam 4 at low speed. The reason is that when the optical beam 4 is transferred at high speed, the objective lens 3 is vibrated, which results in a larger error in the measured tilt amount.

As described above, according to the second example, the drive control circuit 15 stores the tilt state of the optical disc 1. Therefore, the gain of the gain variable amplifier 13 can be controlled in real time in accordance with the amount of tilt that occurs. As such, the information recording can be performed on the optical disc 1 even when the optical disc 1 has a large tilt amount.

Next, the case where the optical disc 1 is rotated at CAV (Constant Angular Velocity) will be described. In order to improve the data transfer rate at an outer periphery of the optical disc 1, the optical disc 1 can be rotated at CAV. Since the linear velocity is larger especially at the outer periphery of the optical disc 1 in this case, the phenomenon described in the first example is easily generated. According to the second example, the drive control circuit 15 manages the position of the optical beam 4 and the rotation speed of the spindle motor 5. Therefore, the gain of the gain variable amplifier 13 can be switched in accordance with the linear velocity of the track to which the optical beam 4 is directed.

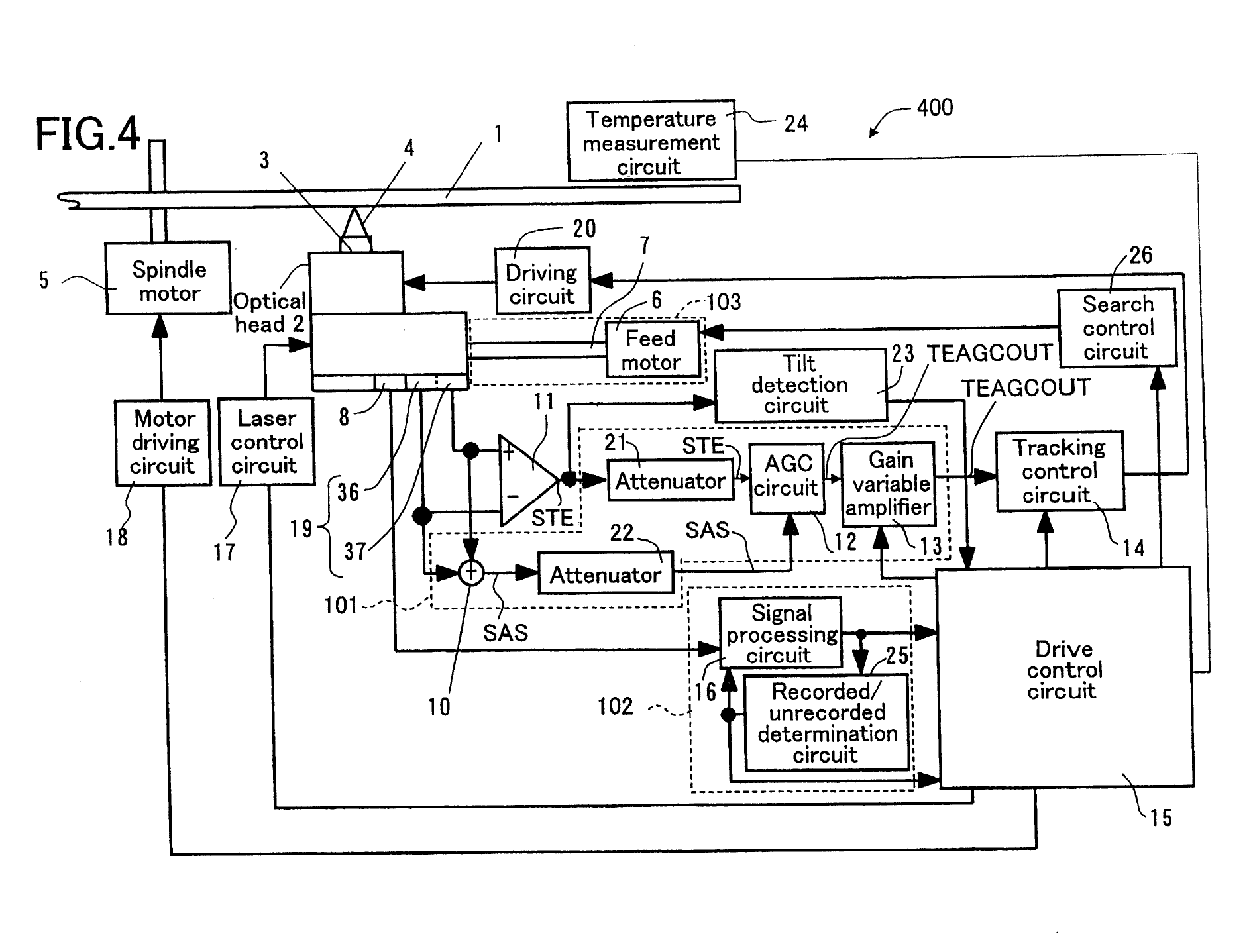

(Example 3) FIG. 4 shows an optical recording and reproduction apparatus 400 according to a third example of the present invention.

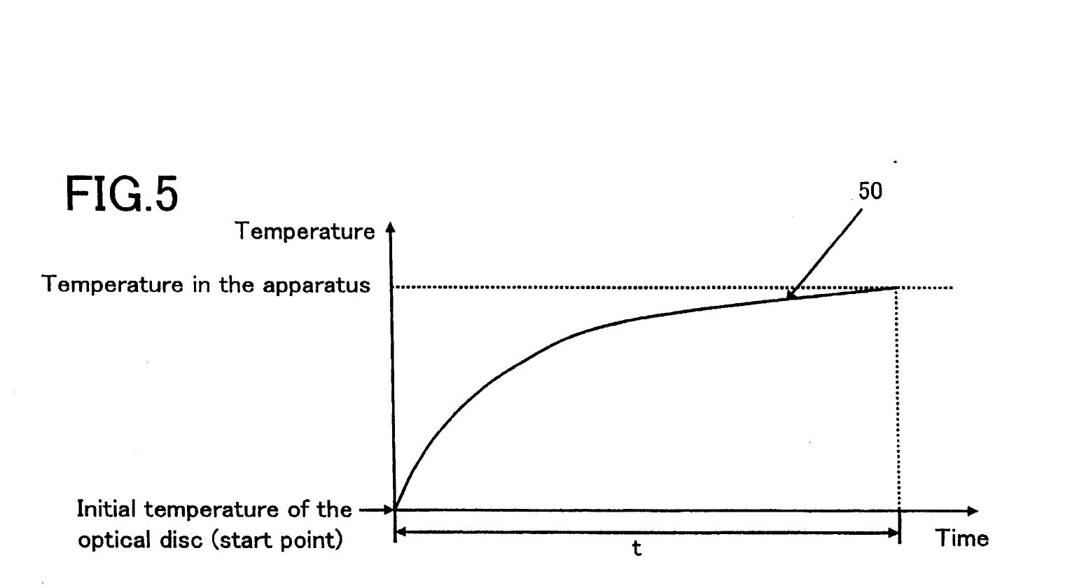

As described above, information recording on the optical disc 1 is performed by heating the recording film using the optical beam 4 to evaporate a portion of the recording film so that the reflectance of an area of the recording film in which information has been recorded is different from the reflectance of an area of the recording film in which no information has been recorded. Accordingly, in order to generate a recording mark, it is necessary that the temperature of the recording film should be raised to a sufficiently high level. In the case where the temperature of the optical disc 1 is relatively low (for example, at the start point or in the vicinity thereof shown in FIG. 5), the temperature of the recording film cannot be raised to a sufficiently high level merely by irradiating the optical disc 1 with the optical beam 4 of the usual intensity. This results in a delay in forming a recording mark, and a period in which the light amount sum signal is kept at V3 (FIG. 2) for a relatively long time is generated. As described above, when this state occurs, the value of the gain of the tracking control system is decreased and the tracking control system becomes unstable. In order to avoid this, the gain of the gain variable amplifier 13 is changed in accordance with the temperature of the optical disc 1. This will be described with reference to the optical recording and reproduction apparatus 400 shown in FIG. 4.

In FIG. 4, identical elements previously discussed with respect to FIG. 3 bear identical reference numerals and the detailed descriptions thereof will be omitted. The optical recording and reproduction apparatus 400 includes a temperature measurement circuit 24 in addition to the elements of the optical recording and reproduction apparatus 300 shown in FIG. 3.

The temperature measurement circuit 24 includes a temperature sensor, a buffer amplifier and the like although not shown. The drive control circuit 15 receives the output from the temperature measurement circuit 24 via an A/D converter (not shown) included in the drive control circuit 15. The temperature sensor of the temperature measurement circuit 24 is provided very closely to the optical disc 1 and measures the temperature of the optical disc 1. The output from the temperature measurement circuit 24 is input to the drive control circuit 15 via the A/D converter in the drive control circuit 15. By accumulating calibrated data regarding the temperature measurement circuit 24 while, for example, the optical recording and reproduction apparatus 400 is produced, the temperature of the optical disc 1 can be measured relatively accurately.

Since the temperature of the optical disc 1 is detected as described above and the gain of the gain variable amplifier 13 is changed in accordance with the detected temperature, the tracking control system can be stabilized even when the light amount sum signal amplitude is kept at V3 (FIG. 2) for a relatively long time.

This will be more specifically described. FIG. 5 shows a temperature change of the optical disc 1. In FIG. 5, it is assumed that the temperature inside the optical recording and reproduction apparatus 400 is constant for the sake of simplicity. It is also assumed that the optical disc 1 is inserted to the optical recording and reproduction apparatus 400 from an external area having a lower temperature than that of the temperature of the apparatus 400. In FIG. 5, solid line 50 represents the temperature of the optical disc 1. A time period “t” in which the temperature of the optical disc 1 is equal to the temperature inside the optical recording and reproduction apparatus 400 is determined by the thermal capacitance of the optical disc 1. Thus, the time period “t” can be calculated by measuring the starting temperature shown in FIG. 5. The starting temperature can be measured as follows. A rising and falling mechanism (not shown) is attached to the temperature sensor in the temperature measurement circuit 24, and the temperature sensor is put into direct contact with the optical disc 1 once before the spindle motor 5 is driven, so as to measure the temperature. In this manner, the drive control circuit 15 can adjust the gain of the gain variable amplifier 13 in accordance with the temperature of the optical disc 1.

Next, information reproduction performed by the optical recording and reproduction apparatus 400 will be described. The recorded/unrecorded determination section 25 shown in FIG. 4 includes, for example, a voltage comparator (not shown). When information has been recorded on a track of the optical disc 1, a signal is output from the signal processing circuit 16. This output is compared with a prescribed value, and the comparison result is output to the drive control circuit 15 via the signal processing circuit 16. When the information is recorded at the position on the optical disc 1 to which the optical beam 4 is directed, the drive control circuit 15 decreases the gain of the gain variable amplifier 13, for the following reason. As is clear from comparing the period between time T0 and time T1 with the period between time T4 and time T5, in a track where information has been recorded, the light amount sum signal amplitude is decreased and the tracking error signal amplitude is increased. Therefore, when the AGC circuit 12 is operated, the gain of the tracking control system is increased.

Accordingly, when it is detected that information has been recorded on a track, the tracking control system can be stabilized even during information reproduction, by decreasing the gain of the gain variable amplifier. Depending on the result obtained by an information detection circuit, the operation of the AGC circuit in the signal processing circuit 16 is turned on or off. This occurs for the following reason: When the AGC circuit is operated for an area of a track where no information is recorded, the gain of the AGC circuit is unnecessarily increased and noise is unnecessarily amplified. In order to avoid this, the AGC circuit for making the signal amplitude constant is disabled for the area where no information is recorded.

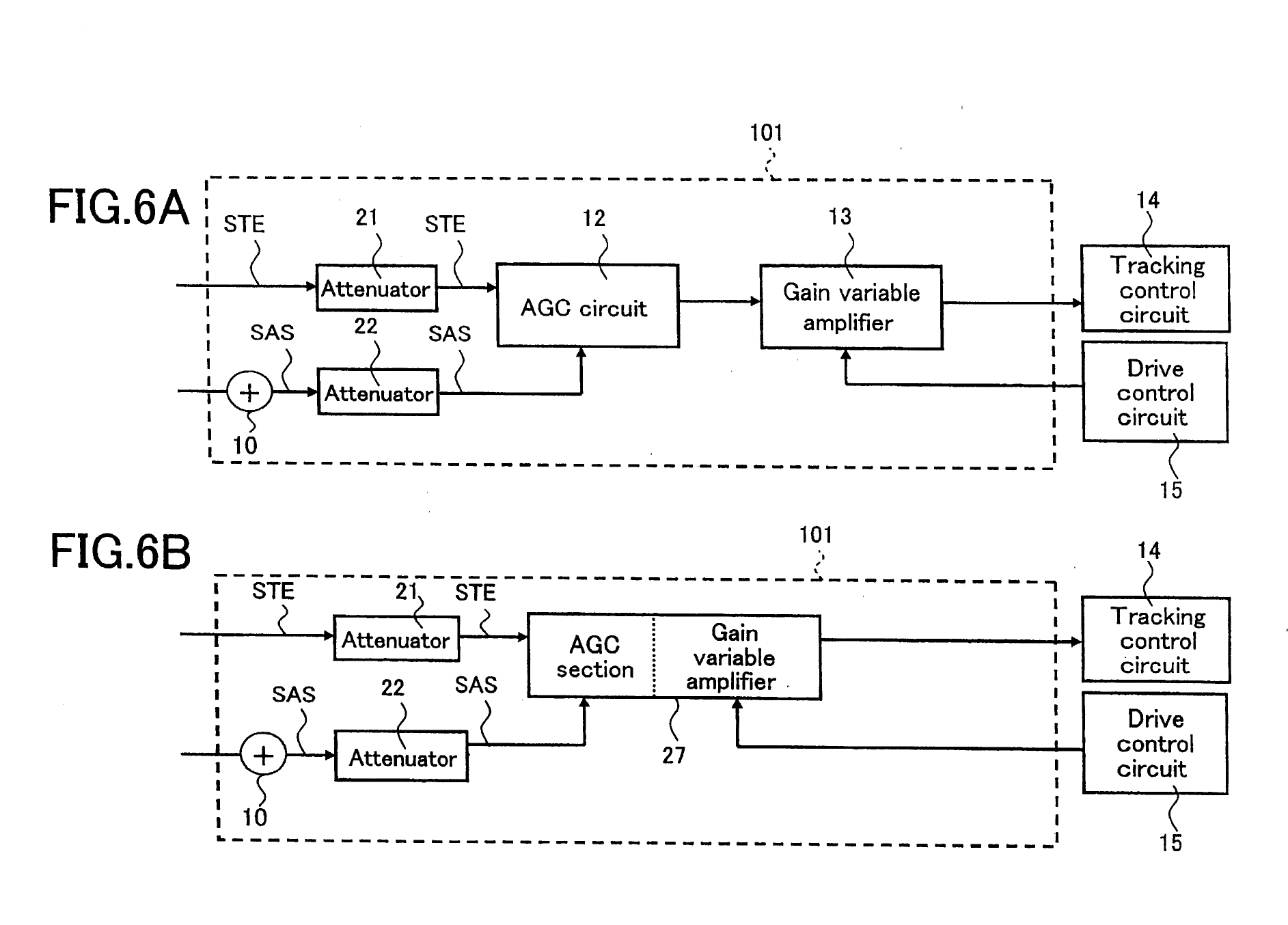

The present invention is not limited to any of the above examples. For example, the following modifications are possible. In the above examples, as shown in FIG. 6A, the attenuators 21 and 22, the AGC circuit 12, and the gain variable amplifier 13 are provided between the differential amplifier 11 and the tracking control circuit 14. Instead, as shown in FIG. 6B, an amplifier 27 including an AGC section and a gain variable amplifier in an integral manner may be provided. The amplifier 27 has a gain thereof changed based on at least one of an instruction from the drive control circuit 15 and the light amount sum signal SAS. Specifically, the amplifier 27 can be realized by structuring an amplifier on an output stage of the AGC circuit such that the gain can be externally controlled.

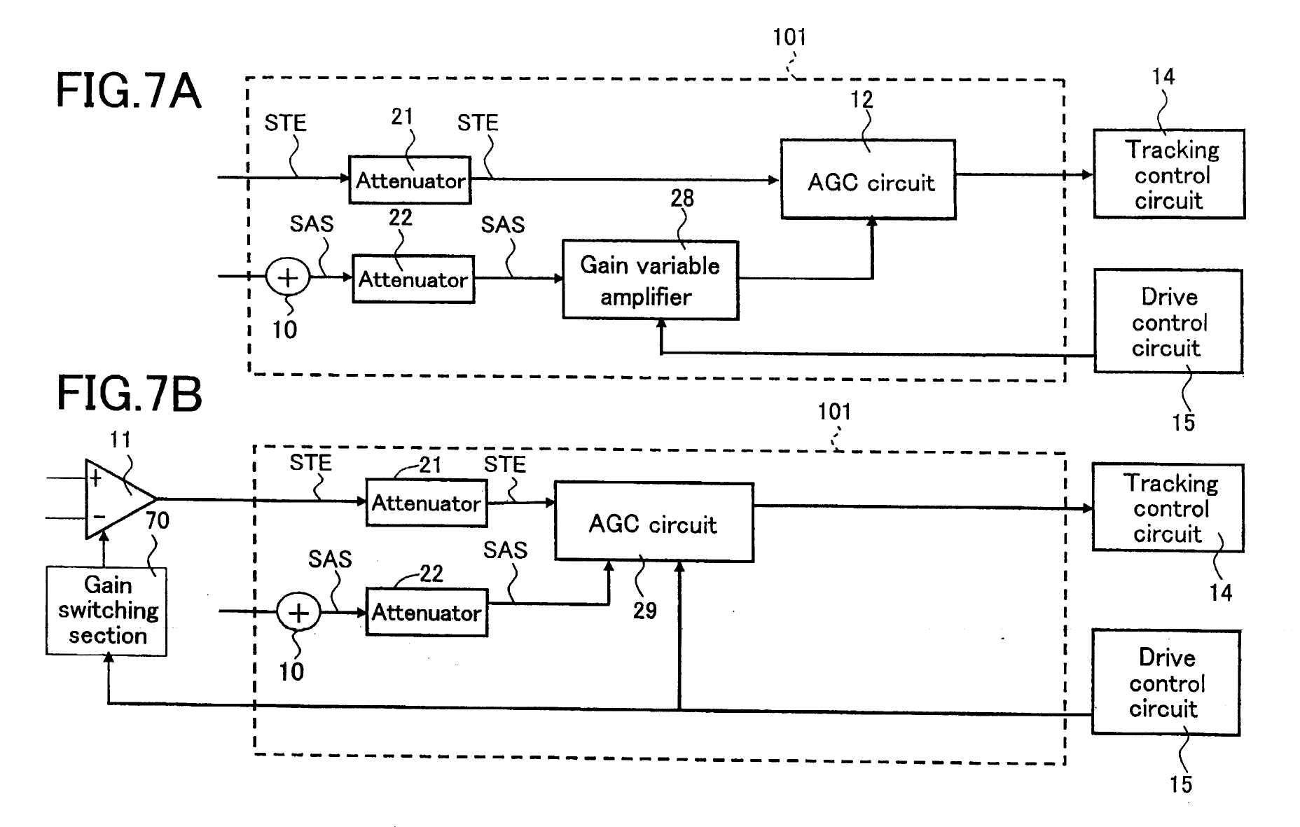

Alternatively, as shown in FIG. 7A, a gain variable amplifier 28 may be provided for receiving the light amount sum signal SAS. The gain variable amplifier 28 amplifies the light amount sum signal SAS and outputs the amplified light amount sum signal SAS. The gain variable amplifier 28 has a gain thereof adjusted by the drive control circuit 15. The AGC circuit 12 amplifies the tracking error signal STE and outputs the amplified tracking error signal STE. The AGC circuit 12 adjusts the gain of the AGC circuit 12 based on the amplified tracking error signal STE. With such a structure also, it is possible to compensate for the change in the TE/AS ratio during recording, which is described in the first through third examples.

A change in a signal amplitude which is generated by the difference in the laser power between recording and reproduction is absorbed by the attenuators 21 and 22. Therefore, as shown in FIG. 7B, an AGC circuit 29 may be provided which can stop the AGC operation thereof by the output from the drive control circuit 15 during recording. In addition, a gain switching section 70 for switching the gain of the differential amplifier 11 may be provided. The gain switching section 70 switches the gain of the differential amplifier 11 by an instruction from the drive control circuit 15 depending on whether the information is to be recorded on the optical disc 1 or the information is to be reproduced from the optical disc 1. Since the gain of the differential amplifier 11 is also switched, the gain varying range of the amplification section 101 can be suppressed to be small, which simplifies the structure of the amplification section 101.

In the above examples, the attenuators 21 and 22 are provided separately from the differential amplifier 11 and the adder 10. The attenuators 21 and 22 may be incorporated into the differential amplifier 11 and the adder 10. In the above examples, the AGC circuit 12 and the gain variable amplifier 13 are provided as hardware. Instead, the functions of the AGC circuit 12 and the gain variable amplifier 13 may be performed by software in a DSP or the like, together with the operation of the tracking control circuit 14.

As has been described so far, according to the present invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; and a control section for adjusting the prescribed value of the gain of the amplification section. The control section adjusts the prescribed value of the gain of the amplification section based on a linear velocity of the recording medium.

According to the present invention, the gain of the amplification section for amplifying the output from the tracking error detection section during recording is switched in accordance with the linear velocity. Owing to such a structure, even when the recording conditions including the intensity of the optical beam directed to a desired position on the track are offset from the recording conditions for the recording medium itself due to the change in the linear velocity, and as a result, the amplitude of the tracking error signal during recording is changed from the value under the recording conditions of the recording medium itself, the total gain of the tracking control system can be appropriate. Thus, even when the recording medium is rotated at an arbitrary linear velocity, stable information recording can be performed.

According to the present invention, the control section adjusts the prescribed value of the gain of the amplification section when recording the information on the recording medium.

Owing to such a structure, even when a recording medium with which the tracking error signal amplitude is decreased during recording is used, the gain of the tracking control system can be compensated for by the amplification section and thus stable information recording can be performed.

According to the present invention, the recording and reproduction apparatus further includes a determination section for determining whether or not information is recorded at a position, which is irradiated with the optical beam, on the recording medium. The control section changes the prescribed value of the gain of the amplification section based on the result of the determination section on whether or not the information is recorded at the position, which is irradiated with the optical beam, on the recording medium.

Owing to such a structure, stable information reproduction is possible even from a recording medium with which the tracking error signal is changed before and after recording. For example, stable information reproduction is made possible even from a recording medium with which the post-recording tracking error signal amplitude is greater than the pre-recording tracking error signal amplitude.

According to the present invention, the determination section includes a reproduction section for reproducing the information recorded on the recording medium; and a comparison section for comparing an output value from the reproduction section and a prescribed value. The determination section determines, based on the result of the comparison, whether or not the information is recorded at the position, which is irradiated with the optical beam, on the recording medium.

Owing to such a structure, a determination section for determining whether or not information is recorded on the track can be specifically structured easily.

According to the present invention, the amplification section includes an amount signal output section for outputting an amount signal of reflected light based on a light amount reflected by the recording medium; a first gain variable amplification section having a value of a gain thereof changed based on the amount signal of the reflected light; and a second gain variable amplification section having a value of a gain thereof adjusted by the control section.

Owing to such a structure, a change in the tracking error signal amplitude, which occurs when the intensity of the optical beam is different between recording and reproduction or when the reflectance of the recording medium is changed, can be compensated for by the amplification section. In addition, a change in the tracking error signal amplitude, which occurs by the offset of the recording conditions, can be compensated for by the amplification section.

According to the present invention, the amplification section includes an amount signal output section for outputting an amount signal of reflected light based on a light amount reflected by the recording medium; and a gain variable amplification section having a value of a gain thereof changed based on at least one of the amount signal of the reflected light and an instruction from the control section.

Owing to such a structure, a change in the tracking error signal amplitude, which occurs when the intensity of the optical beam is different between recording and reproduction or when the reflectance of the recording medium is changed, can be compensated for by the amplification section. In addition, a change in the tracking error signal amplitude, which occurs by the offset of the recording conditions, can be compensated for by the amplification section.

According to the present invention, the amplification section includes an amount signal output section for outputting an amount signal of reflected light based on a light amount reflected by the recording medium; a third gain variable amplification section for amplifying and outputting the amount signal of the reflected light, the third gain variable amplification section having a value of a gain thereof adjusted by the control section; and a fourth gain variable amplification section for amplifying and outputting the tracking error signal, the fourth gain variable amplification section having a value of a gain thereof adjusted based on the amount signal, of the reflected light, amplified by the third gain variable amplification section.

Owing to such a structure, a change in the tracking error signal amplitude, which occurs when the intensity of the optical beam is different between recording and reproduction or when the reflectance of the recording medium is changed, can be compensated for by the amplification section. In addition, a change in the tracking error signal amplitude, which occurs by the offset of the recording conditions, can be compensated for by the amplification section.

According to the present invention, the amount signal output section outputs an amount signal, of reflected light, having a fixed amplitude when recording the information on the recording medium.

Owing to such a structure, even when the intensity of the optical beam is changed during recording, the gain of the prescribed gain variable amplification section is not changed. Thus, even when the recording conditions are offset, the gain of the tracking control system can be kept substantially constant.

According to the present invention, a recording film of the recording medium contains an organic pigment material which is irreversibly changed using heat generated by irradiation with the optical beam.

According to the present invention, stable information recording is possible even on a recording medium containing an organic pigment material which is irreversibly changed using heat generated by an optical beam.

According to the present invention, the recording and reproduction apparatus further includes a gain switching section for switching a value of a gain of the tracking error detection section. The gain switching section switches the value of the gain of the tracking error detection section based on whether information is to be recorded on the recording medium or information is to be reproduced from the recording medium.

Owing to such a structure, even when the intensity of the optical beam is significantly different between recording and reproduction, the gain of the tracking error detection section can be switched. Therefore, the gain varying range of the amplification section is suppressed to be small. Thus, the amplification section can be structured easily.

According to the present invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a tilt detection section for detecting a tilt between a normal with respect to a position, which is irradiated with the optical beam, on the recording medium and an optical axis of the optical beam. The control section adjusts the prescribed value of the gain of the amplification section based on the detected tilt.

According to the present invention, the gain of the amplification section for amplifying the output of the tracking error detection section during recording is switched in accordance with the detected tilt amount. Owing to such a structure, the total gain of the tracking control system can be appropriate even in the following case: The recording conditions including the intensity of the optical beam directed to a desired position on the track are offset from the recording conditions for the recording medium itself due to the occurrence of a tilt; and a result, the amplitude of the tracking error signal during recording is changed from the value under the recording conditions of the recording medium itself. Thus, even when the tilt occurs between the recording medium and the optical axis of the optical beam, stable information recording can be performed.

According to the present invention, a recording and reproduction apparatus for irradiating a recording medium having a track with an optical beam to record information on and reproduce information from the recording medium is provide. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a sensitivity detection section for detecting a recording sensitivity of the recording medium. The control section adjusts the prescribed value of the gain of the amplification section based on the detected recording sensitivity.

According to the present invention, the gain of the amplification section for amplifying the output of the tracking error detection section during recording is switched in accordance with the detected recording sensitivity. When recording conditions suitable for a usual recording medium are used for recording information on a recording medium having a significantly different recording sensitivity from that of the usual recording medium, the recording conditions including the intensity of the optical beam are offset from the recording conditions for the recording medium itself; and as a result, the amplitude of the tracking error signal during recording is changed from the value under the recording conditions of the recording medium itself. According to the present invention, even in such a case, the total gain of the tracking control system can be appropriate, and stable information recording can be performed.

According to the present invention, the recording medium has sensitivity information representing the recording sensitivity recorded thereon. The sensitivity detection section detects the sensitivity information based on reflected light by the recording medium.

Owing to such a structure, the recording sensitivity of the recording medium can be detected.

According to the present invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a transfer section for transferring the optical beam in a radial direction of the recording medium. The control section adjusts the prescribed value of the gain of the amplification section based on a position of the optical beam in the radial direction.

According to the present invention, the gain of the amplification section for amplifying the output of the tracking error detection section during recording is switched in accordance with the position on the recording medium to which the optical beam is directed. When the position on a recording medium rotated by CAV to which the optical beam is directed is changed, the same problem occurs as that which occurs when the linear velocity is changed. The recording conditions including the intensity of the optical beam directed to the desired position on the track are offset from the recording conditions for the recording medium itself; and as a result, the amplitude of the tracking error signal during recording is changed from the value under the recording conditions of the recording medium itself. According to the present invention, even in such a case, the total gain of the tracking control system can be appropriate. Thus, even when the recording medium is rotated by CAV and the position on the recording medium to which the optical beam is directed is changed, stable information recording can be performed.

According to the present invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a modulation section for modulating the optical beam based on information to be recorded on the recording medium. The control section adjusts the prescribed value of the gain of the amplification section based on an average intensity of the modulated optical beam.

According to the present invention, the gain of the amplification section for amplifying the output of the tracking error detection section during recording is switched in accordance with the average intensity of the optical beam. Owing to such a structure, the total gain of the tracking control system can be appropriate even in the following case: The recording conditions are offset from the recording conditions for the recording medium itself due to the decrease in the average intensity of the optical beam depending on the pattern or type of the recording signal; and as a result, the amplitude of the tracking error signal during recording is changed from the value under the recording conditions of the recording medium itself. Since the total gain of the tracking control system can be appropriate even in such a case, arbitrary information can be stably recording on the recording medium.

According to the present invention, a recording and reproduction apparatus for irradiating a recording medium having a track with an optical beam to record information on and reproduce information from the recording medium is provided. The recording and reproduction apparatus includes a tracking error detection section for detecting a positional offset between the optical beam and the track and outputting a tracking error signal corresponding to the positional offset; an amplification section for amplifying, based on a prescribed value of a gain, the tracking error signal to be output, wherein the prescribed value of the gain is adjustable; a tracking control section for controlling a position of the optical beam based on the tracking error signal amplified by the amplification section; a control section for adjusting the prescribed value of the gain of the amplification section; and a temperature measurement section for measuring a temperature of the recording medium. The control section adjusts the prescribed value of the gain of the amplification section based on the measured temperature.

According to the present invention, the gain of the amplification section for amplifying the output of the tracking error detection section during recording is switched in accordance with the temperature of the recording medium. Owing to such a structure, the total gain of the tracking control system can be appropriate even in the following case: The recording conditions are offset from the recording conditions for the recording medium itself due to the change in the recording sensitivity which occurs in accordance with the change in the temperature of the recording medium; and as a result, the amplitude of the tracking error signal during recording is changed from the value under the recording conditions of the recording medium itself. Since the total gain of the tracking control system can be appropriate in such a case, even in an environment in which the temperature significantly changes, stable information recording on the recording medium can be performed.

When the linear velocity is increased and thus the intensity of the optical beam directed to a desired position on the track is decreased, the output from the AGC circuit is reduced and thus the gain of the tracking control system is decreased. According to the present invention, even in such a case, the decrease in the gain can be compensated for by the gain variable amplifier provided on the stage after the AGC circuit, so that the tracking control system can be stabilized. Since the gain of the gain variable amplifier can be switched in accordance with the linear velocity, the tracking control system can be stabilized at any linear velocity.

An optical disc usable in an optical recording and reproduction apparatus according to the present invention has information regarding the recording sensitivity of the optical disc recorded thereon. Such information is recorded in an inner portion of the recording medium. The optical recording and reproduction apparatus of the present invention can read the information regarding the recording sensitivity from the optical disc mounted thereon, and adjust the gain of the gain variable amplifier so as to be compatible to the recording sensitivity of the optical disc. Owing to such an operation, the tracking control system can be stabilized even in the following case: When an optical beam used for a usual optical disc is used for recording information on an optical disc having a very low level of recording sensitivity; and as a result, the output from the AGC circuit is lowered.

According to the present invention, the amount of a tilt is detected and the gain of the gain variable amplifier is adjusted in accordance with the detected tilt amount. Thus, even when the intensity of the optical beam directed to a desired position on the recording medium is lowered by a large tilt amount and the output from the AGC circuit is decreased, stable information recording can be performed.

According to the present invention, even when the linear velocity is changed in accordance with the position on the recording medium to which the optical beam is directed due to the spindle motor being rotated by CAV, stable information recording is possible regardless of the position on the optical disc. The reason is that the gain of the gain variable amplifier is changed in accordance with the position on the optical disc to which the optical beam is directed.

According to the present invention, the temperature of the optical disc is measured and the gain of the gain variable amplifier is changed in accordance with the measurement result. Thus, the tracking control system can be stabilized even in the following case: The temperature of the optical disc itself is very low, and the temperature of the recording film cannot be sufficiently raised merely by using an optical beam having a normal intensity;

and as a result, the output from the AGC circuit is lowered.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section; and
a control section for adjusting the prescribed value of the gain of the amplification section,
wherein the control section adjusts the prescribed value of the gain of the amplification section based on a linear velocity of the recording medium.

2. A recording and reproduction apparatus according to claim 1, wherein the control section adjusts the prescribed value of the gain of the amplification section when recording the information on the recording medium.

3. A recording and reproduction apparatus according to claim 1, further comprising a determination section for determining whether or not information is recorded at a position, which is irradiated with the optical beam, on the recording medium,
wherein the control section changes the prescribed value of the gain of the amplification section based on the result of the determination section on whether or not the information is recorded at the position, which is irradiated with the optical beam, on the recording medium.

4. A recording and reproduction apparatus according to claim 3, wherein the determination section includes:
a reproduction section for reproducing the information recorded on the recording medium; and
a comparison section for comparing an output value from the reproduction section and a prescribed value,
wherein the determination section determines, based on the result of the comparison, whether or not the information is recorded at the position, which is irradiated with the optical beam, on the recording medium.

5. A recording and reproduction apparatus according to claim 1, wherein the amplification section includes:
an amount signal output section for outputting an amount signal of reflected light based on a light amount reflected by the recording medium;
a first gain variable amplification section having a value of a gain thereof changed based on the amount signal of the reflected light; and
a second gain variable amplification section having a value of a gain thereof adjusted by the control section.

6. A recording and reproduction apparatus according to claim 5, wherein the amount signal output section outputs an amount signal of the reflected light having a fixed amplitude when recording the information on the recording medium.

7. A recording and reproduction apparatus according to claim 1, wherein the amplification section includes:
an amount signal output section for outputting an amount signal of reflected light based on a light amount reflected by the recording medium; and
a gain variable amplification section having a value of a gain thereof changed based on at least one of the amount signal of the reflected light and an instruction from the control section.

8. A recording and reproduction apparatus according to claim 7, wherein the amount signal output section outputs an amount signal, of reflected light, having a fixed amplitude when recording the information on the recording medium.

9. A recording and reproduction apparatus according to claim 1, wherein the amplification section includes:
an amount signal output section for outputting an amount signal of reflected light based on a light amount reflected by the recording medium;
a third gain variable amplification section for amplifying and outputting the amount signal of the reflected light, the third gain variable amplification section having a value of a gain thereof adjusted by the control section; and
a fourth gain variable amplification section for amplifying and outputting the tracking error signal, the fourth gain variable amplification section having a value of a gain thereof adjusted based on the amount signal, of the reflected light, amplified by the third gain variable amplification section.

10. A recording and reproduction apparatus according to claim 9, wherein the amount signal output section outputs an amount signal, of reflected light, having a fixed amplitude when recording the information on the recording medium.

11. A recording and reproduction apparatus according to claim 1, wherein a recording film of the recording medium contains an organic pigment material which is irreversibly changed using heat generated by irradiation with the optical beam.

12. A recording and reproduction apparatus according to claim 1, further comprising a gain switching section for switching a value of a gain of the tracking error detection section, wherein the gain switching section switches the value of the gain of the tracking error detection section based on whether information is to be recorded on the recording medium or information is to be reproduced from the recording medium.

13. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section;
a control section for adjusting the prescribed value of the gain of the amplification section; and
a tilt detection section for detecting a tilt between a normal with respect to a position, which is irradiated with the optical beam, on the recording medium and an optical axis of the optical beam,
wherein the control section adjusts the prescribed value of the gain of the amplification section based on the detected tilt.

14. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section;
a control section for adjusting the prescribed value of the gain of the amplification section; and
a sensitivity detection section for detecting a recording sensitivity of the recording medium,
wherein the control section adjusts the prescribed value of the gain of the amplification section based on the detected recording sensitivity.

15. A recording and reproduction apparatus according to claim 14, wherein:
the recording medium has sensitivity information representing the recording sensitivity recorded thereon, and
the sensitivity detection section detects the sensitivity information based on reflected light by the recording medium.

16. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section;
a control section for adjusting the prescribed value of the gain of the amplification section; and
a transfer section for transferring the optical beam in a radial direction of the recording medium,
wherein the control section adjusts the prescribed value of the gain of the amplification section based on a position of the optical beam in the radial direction.

17. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section;
a control section for adjusting the prescribed value of the gain of the amplification section; and
a modulation section for modulating the optical beam based on information to be recorded on the recording medium,
wherein the control section adjusts the prescribed value of the gain of the amplification section based on an average intensity of the modulated optical beam.

18. A recording and reproduction apparatus for irradiating a recording medium having a track with an optical beam to record information on and reproduce information from the recording medium, the recording and reproduction apparatus comprising:
a tracking error detection section for detecting a positional offset between the optical beam and the track and outputting a tracking error signal corresponding to the positional offset;
an amplification section for amplifying, based on a prescribed value of a gain, the tracking error signal to be output, wherein the prescribed value of the gain is adjustable;
a tracking control section for controlling a position of the optical beam based on the tracking error signal amplified by the amplification section;
a control section for adjusting the prescribed value of the gain of the amplification section; and
a temperature measurement section for measuring a temperature of the recording medium,
wherein the control section adjusts the prescribed value of the gain of the amplification section based on the measured temperature.
